(19) United States
(12) Patent Application Publication
(10) Pub. No.: US 2006/0098234 A1
(43) Pub. Date: May 11, 2006

(54) Printing apparatus, printing method, and printing program

(76) Inventors: Kazuo Tani, Chiba-shi (JP); Norimitsu Sambongi, Chiba-shi (JP); Shinji Nureki, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/267,772

(22) Filed: Nov. 3, 2005

(30) Foreign Application Priority Data
Nov. 8, 2004 (JP) 2004-323190

(51) Int. Cl. H04N 1/40

(52) U.S. Cl. 358/3.28

(57) ABSTRACT

To print a code to be read by a machine as well as information to be read by a user on a limited print surface with efficiency. An ID pattern is defined in a frequency domain and is transformed through an inverse Fourier transform. As a result of the inverse Fourier transform, the ID pattern becomes a pattern (ID background image) dispersed across a screen. In the printing apparatus according to the present invention, the ID background image is set as a background image, on which human-readable information composed of characters, images (designs), and/or the like are printed. Even thought the ID background image is lost, in a portion in which the human-readable information printed, it is possible to restore the ID pattern by Fourier-transforming the pattern in a remaining portion of the ID background image. A print medium, on which the human-readable information is printed with the ID background image as a background, is photographed with a camera provided for a mobile telephone, and photographed image data is transmitted from the mobile telephone to a URL server apparatus. The URL server receives the photographed image data from the mobile telephone, to subject the data to the Fourier transform, to thereby extract the ID pattern therefrom.

### BACKGROUND OF THE INVENTION

1. Field of the Invention

The present invention relates to a printing apparatus, a printing method, and a printing program. In particular, the invention relates to a printing apparatus, a printing method, and a printing program for printing for instance, an original image with a background image, the background image having ID information embedded therein in a frequency domain.

2. Description of the Related Art

In recent years, additional information has been attached to images by, for instance, embedding electronic watermarks in the images or printing two-dimensional barcodes in the vicinity of the images.

The electronic watermarks or the two-dimensional barcodes are associated with, for instance, uniform resource locators (URLs). Users can automatically connect their mobile telephones to websites designated by the URLs by photographing the images in which the electronic watermarks have been embedded, or the two-dimensional barcodes, for instance, with cameras provided for the mobile telephones.

Generally, such images containing additional information are printed using sophisticated printing apparatuses installed in printing factories or the like. On the other hand, like a receipt described in JP 2000-235669 A, techniques have also been proposed with which additional information is printed using small-scale printing apparatuses with only unsophisticated printing functions, such as receipt printing apparatuses of cash registers installed in stores.

According to the invention, additional information is printed on a receipt in the form of a two-dimensional barcode, and exceptional processing, such as returns and exchanges of commodities, is efficiently performed using the additional information.

However, when codes to be read by machines, such as two-dimensional barcodes, are printed on print media having limited print areas, such as receipts, there occurs a problem in that the areas of regions, in which information to be read by users is printed, are reduced.

### SUMMARY OF THE INVENTION

It is therefore an object of the present invention to print a code to be read by a machine as well as information to be read by a user on a limited print surface with efficiency.

In order to attain the above-described object, according to a first aspect of the present invention, there is provided a printing apparatus including: ID image acquisition means for acquiring an ID image in which ID information has been defined in a frequency domain; human-readable information acquisition means for acquiring human-readable information including at least one of a character and an image; print information generation means for generating print information by arranging the acquired human-readable information in a partial region of the acquired ID image; and print means for printing the ID image and the human-readable information on a print medium using the generated print information.

According to a second aspect of the present invention, there is provided a printing apparatus according to the first aspect, in which an area of the partial region is 50% or less of an area of the ID image.

According to a third aspect of the present invention, there is provided a printing apparatus according to the first or the second aspect, further including binary dot acquisition means for acquiring a predetermined arrangement of binary dots in accordance with a gradation of a surface element that is a print unit, in which the binary dot acquisition means acquires an arrangement of binary dots for each surface element of the generated print information, and the print means prints the acquired arrangement of binary dots in monochrome.

According to a fourth aspect of the present invention, there is provided a printing apparatus according to the third aspect, in which the binary dot acquisition means adjusts density of the ID image using a gradation system based on the arrangement of binary dots.

According to a fifth aspect of the present invention, there is provided a printing method used for a computer, which includes ID image acquisition means, human-readable information acquisition means, print information generation means, and print means, the method including: acquiring an ID image having ID information defined in a frequency domain, through the ID image acquisition means; acquiring human-readable information including at least one of characters and images, through the human-readable information acquisition means; generating print information, through the print information generation means, by arranging the acquired human-readable information in a partial region of the acquired ID image; and printing the ID image and the human-readable information on a print medium, through the generated print information using the print means.

According to a sixth aspect of the present invention, there is provided a printing program for causing a computer to implement: an ID image acquisition function for acquiring an ID image having ID information defined in a frequency domain; a human-readable information acquisition function for acquiring human-readable information including at least one of a character and an image; a print information generation function for generating print information by arranging the acquired human-readable information in a partial region of the acquired ID image; and a printing function for printing the ID image and the human-readable information on a print medium using the generated print information.

According to the present invention, it becomes possible to print a code to be read by a machine as well as information to be read by a user on a limited print surface with efficiency.

### BRIEF DESCRIPTION OF THE DRAWINGS

In the accompanying drawings:

FIG. 1 is an explanatory diagram of an outline according to an embodiment of the present invention;

FIG. 2 is a block diagram showing a construction of an information provision system according to the embodiment of the present invention;

FIG. 3 shows an example of a logical construction of an ID database;

FIG. 4 shows an example of an external appearance of a receipt on which an ID background image is printed;

FIG. 5 is a block diagram showing an example of a functional construction of a printer;

FIG. 6 is an explanatory diagram of an area gradation method;

FIG. 7 is a block diagram showing an example of a hardware construction of the printer;

FIG. 8 is a flowchart for explaining a procedure by which the printer prints a receipt;

FIG. 9 shows an example of an external appearance of a mobile telephone;

FIG. 10A is an explanatory diagram of an example of a screen displayed on the mobile telephone concerning receipt photographing;

FIG. 10B is an explanatory diagram of an example of another screen displayed on the mobile telephone concerning the receipt photographing;

FIG. 11 is a flowchart for explaining a procedure by which the mobile telephone connects to a service server; and

FIG. 12 is an explanatory diagram of a modification of an ID background image printing method.

### DETAILED DESCRIPTION OF THE PREFERRED EMBODIMENTS

### (1) Outline of Embodiment

An ID pattern is defined in a frequency domain and is converted through an inverse Fourier transform. As a result of the inverse Fourier transform, the ID pattern becomes a pattern (ID image: hereinafter referred to as the “ID background image”) that is dispersed across a screen.

In a printing apparatus according to an embodiment of the present invention, the ID background image is set as a background image, on which human-readable information composed of characters, images (designs), and/or the like is printed.

Even though the ID background image is lost in a portion in which the human-readable information is printed, it is possible to restore the ID pattern by Fourier-transforming the pattern in a remaining portion of the ID background image.

It has been confirmed as a result of experiments that even when around 50% of the ID background image is lost, it is possible to restore the original ID pattern.

In this embodiment, a print medium, on which the human-readable information has been printed with the ID background image as a background, is photographed with a camera provided for a mobile telephone and photographed image data is transmitted from the mobile telephone to a URL server apparatus.

The URL server receives the photographed image data from the mobile telephone, and extracts the ID pattern from the received data by Fourier-transforming the received data.

The URL server has ID patterns and URLs stored therein and the ID patterns and URLs are associated with each other. The URL server searches for a URL associated with the extracted ID pattern, and transmits the found URL to the mobile telephone.

The mobile telephone receives the URL from the URL server, and connects to a website designated by the URL to use service provided by the website.

In the manner described above, in this embodiment, a URL is associated with a print medium through an ID background image.

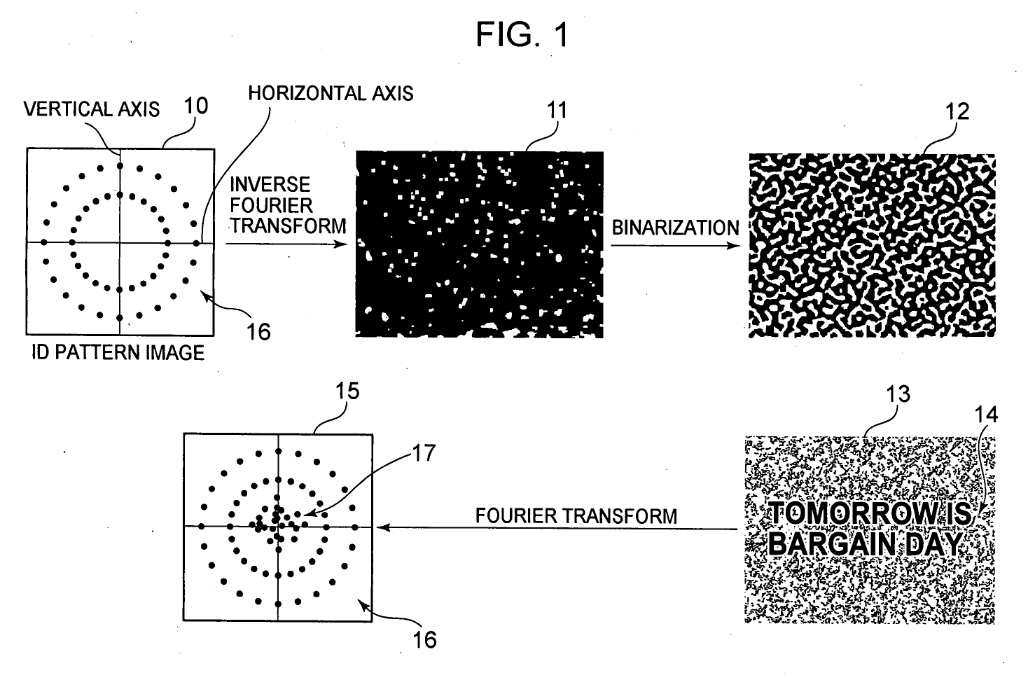

FIG. 1 is an explanatory diagram of an outline of this embodiment.

First, in this embodiment, an ID pattern 10 that is ID information is defined in a frequency domain.

The ID pattern 10 has a construction in which ID pattern components 16 composed of points have been dispersed to form an inner circle and an outer circle.

The origins of a vertical axis and a horizontal axis exist on a low-frequency side and a frequency is increased as a distance from the origins is increased.

When the ID pattern 10 is inversely Fourier-transformed, an ID background image 11 in a real space is obtained. The ID background image 11 becomes an image in which a pattern has been dispersed across the image.

It should be noted that, in defining the ID pattern, it is preferable to select an image which leads to a pattern dispersed across the image as in the illustrated example after being subjected to the inverse Fourier transform.

There is a relation in which the ID background image 11 is obtained by inversely Fourier-transforming the ID pattern 10, while the ID pattern is obtained by Fourier-transforming the ID background image 11.

When an appropriate ID pattern is selected to be subjected to inverse Fourier-transform in the manner described above, information for restoring the ID pattern is dispersed across an image, which generates tolerance for processing such as compression or clipping off.

That is, the information defining the ID pattern is dispersed across the image. Accordingly, even when the image is enlarged/reduced or a part of the image is clipped off, it is possible to restore the ID pattern from information remaining in the image.

In this embodiment, the ID background image 11 is binarized in order to be printed by a small-scale printing apparatus such as a receipt print mechanism of a cash register, a binarized ID background image 12 is generated through the binarization.

Then, the density of the binarized ID background image 12 is adjusted so that the human-readable information can be visually observed, and the human-readable information is printed with the ID background image 12 as a background, to thereby generate printed matter 13.

On the printed matter 13, character information telling that “Tomorrow is a bargain day” is printed as the human-readable information 14.

Digital image data obtained by photographing the printed matter 13 with a camera is Fourier-transformed to obtain an ID pattern 15.

In the ID pattern 15, the ID pattern component 16 is restored. In addition, a frequency component 17 of the human-readable information 14 is formed.

The frequency component 17 of the human-readable information 14 tends to be distributed to be concentrated on the low frequency side, which makes it possible to extract the ID pattern component 16 by distinguishing the ID pattern component 16 from the frequency component 17.

In the manner described above, the ID pattern component 16 restored in the ID pattern 15 is extracted, and it is confirmed that the extracted ID pattern component 16 agrees to the ID pattern component 16 of the ID pattern 10, to thereby identify the ID information contained in the printed matter 13.

### (2) Details of Embodiment

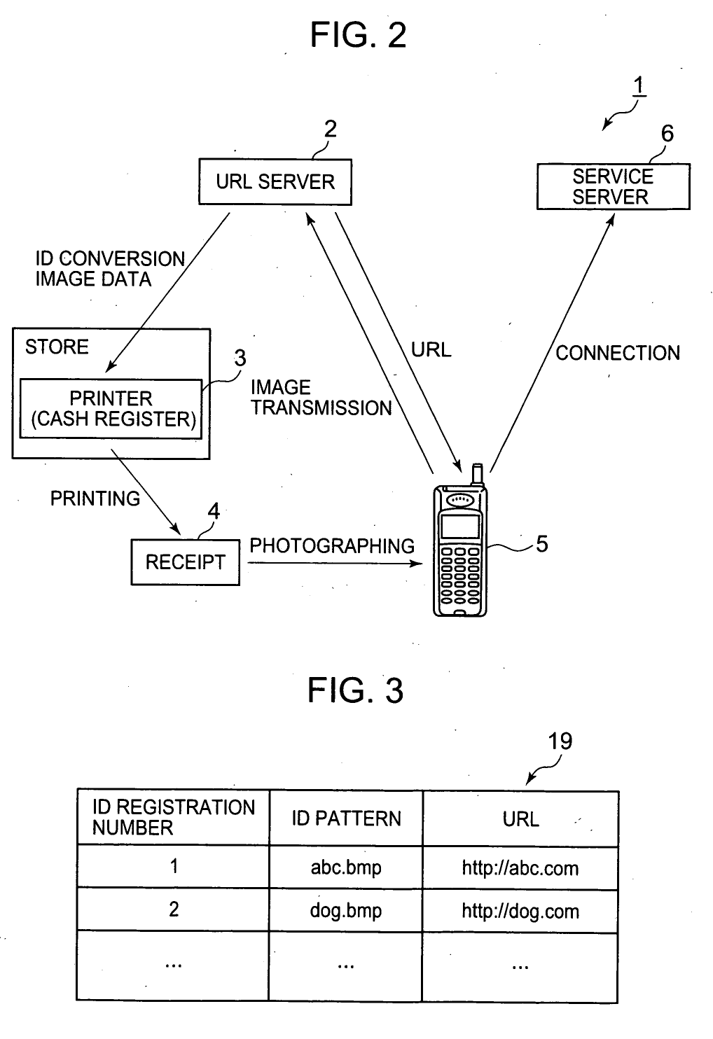

FIG. 2 is a block diagram showing a construction of an information provision system 1 in this embodiment.

As shown in FIG. 2, the information provision system 1 includes a URL server 2, a printer 3, a receipt 4, a mobile telephone 5, and a service server 6.

In FIG. 2, only one printer 3 and only one mobile telephone 5 are illustrated. In reality, however, there exist multiple printers 3 respectively corresponding to multiple printer users and multiple mobile telephones 5 respectively corresponding to multiple mobile telephone users.

The URL server 2 includes an ID database, in which ID patterns and URLs are associated with each other, and is a server apparatus for providing the printer 3 with an ID background image and providing the mobile telephone 5 with a URL, using the ID database.

FIG. 3 shows an example of a logical construction of the ID database.

In the drawing, an ID database 19 includes items of “ID registration number”, “ID pattern”, and “URL”.

The “ID registration number” is a management number for managing ID patterns and URLs, and is uniquely given to respective pairs of the ID patterns and the URLs.

Stored under the “ID pattern” are images (corresponding to the ID pattern 10 in FIG. 1) in which the ID patterns are defined.

Stored under the “URL” are the URLs that are connection information for connection to predetermined websites.

Stored in the ID database 19 are the ID patterns and the URLs that are associated with each other. When an ID pattern is identified, it is possible to obtain a URL corresponding to the ID pattern.

Next, an ID information provision function of the URL server 2 with respect to the printer 3 will be described.

The URL server 2 and the printer 3 are provided such that they are connectable to each other through a network, such as the Internet, and the URL server 2 provides the printer 3 with ID information through the network in the form of an ID background image.

In this embodiment, the URL server 2 generates an ID background image by inversely Fourier-transforming an ID pattern, binarizes the ID background image (corresponding to the ID background image 12 in FIG. 1), and transmits the binarized ID background image to the printer 3.

By binarizing the ID background image and transmitting a result of the binarization to the printer 3 in the manner described above, there is no need to perform image processing at the printer 3. In addition, it becomes possible to reduce the amount of data that the URL server 2 transmits to the printer 3.

It should be noted that this construction is merely an example, and it is possible to adopt another construction, in which the URL server 2 transmits the ID pattern to the printer 3 and the printer 3 performs the inverse Fourier transform and the binarization, or still another construction, in which the URL server 2 performs processing until the inverse Fourier transform and the printer 3 performs the binarization.

Next, a URL provision function of the URL server 2 with respect to the mobile telephone 5 will be described.

The URL server (FIG. 2) receives photographed image data from the mobile telephone 5 obtained by photographing the receipt 4 through a network such as the Internet.

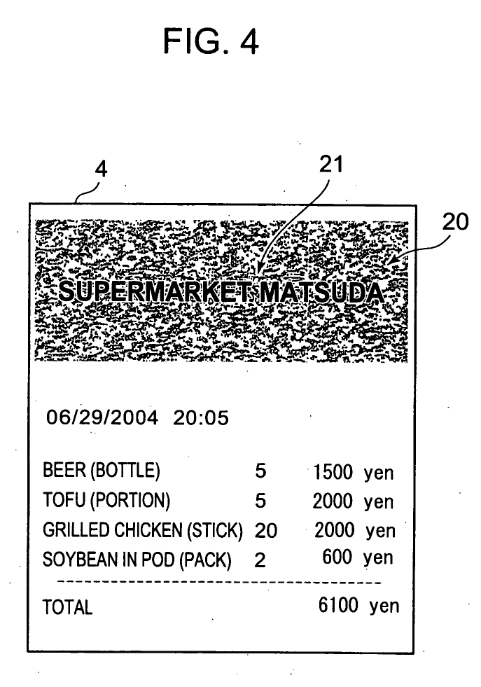

The receipt 4 is a print medium, on which the printer 3 has performed printing, and has an external appearance shown in FIG. 4, for instance.

That is, on the receipt 4, human-readable information 21 (character string “Supermarket Matsuda” in the illustrated example) has been printed with an ID background image 20 as a background.

The URL server (FIG. 2) receives the photographed image data from the mobile telephone 5 and restores the ID pattern by Fourier-transforming the received data.

Next, the URL server 2 extracts the restored ID pattern and compares the extracted ID pattern with the ID patterns stored in the ID database 19.

Then, the URL server 2 transmits a URL associated with an ID pattern identified through the comparison to the mobile telephone 5.

It should be noted that in this embodiment, a construction is adopted in which the Fourier transform of the photographed image and the extraction of the ID pattern are performed at the URL server 2, although it is also possible to adopt a construction, in which the mobile telephone 5 performs processing until the extraction of the ID pattern and transmits the extracted ID pattern to the URL server 2.

When the extraction of the ID pattern is performed by the URL server 2, there is no need to provide the mobile telephone 5 with an image-processing function for the extraction of the ID pattern, and it becomes possible to reduce a load on the mobile telephone 5.

On the other hand, when the extraction of the ID pattern is performed at the mobile telephone 5, the URL server 2 neither has to receive photographed image data transmitted by mistake from the mobile telephone 5 nor has to perform the image-processing, so a load on the URL server 2 can be reduced.

Next, the printer 3 will be described. The printer 3 is, for instances a cash register installed in a checkout area of a store and has a checkout function and a receipt printing function.

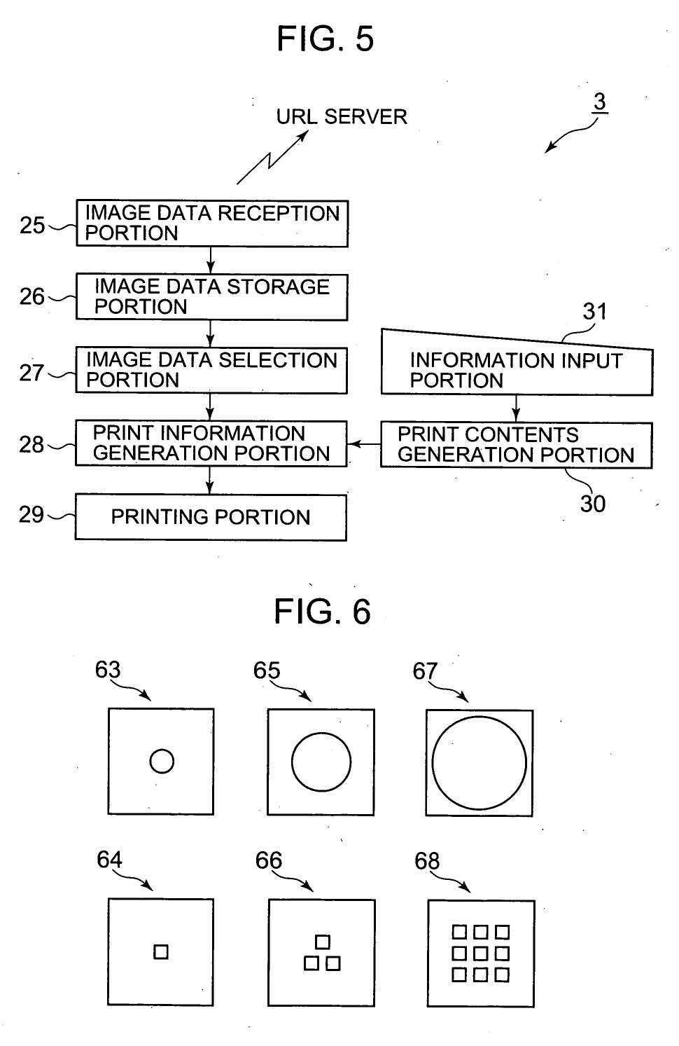

FIG. 5 is a block diagram showing an example of a functional construction of the printer 3.

As shown in FIG. 5, the printer 3 includes an image data reception portion 25, an image data storage portion 26, an image data selection portion 27, a print information generation portion 28, a printing portion 29, a print contents generation portion 30, and an information. input portion 31.

The image data reception portion 25 has connection information to the URL server 2, and connects to the URL server 2 through a network to receive a binarized ID background image from the URL server 2.

As to the ID background image transmitted from the URL server 2 to the image data reception portion 25, it is possible to use a construction, in which the printer 3 issues, a request to the URL server 2 for an ID registration number, or a construction in which the URL server 2 determines which ID background image is to be transmitted.

The image data storage portion 26 is constructed using a storage medium, such as a hard disk or a semiconductor memory, and stores the ID background image received by the image data reception portion 25 from the URL server 2.

The image data storage portion 26 is capable of storing multiple ID background images, and the ID background images stored in the image data storage portion 26 can be distinguished from one another based on the ID registration numbers.

The image data selection portion 27 selects an ID background image to be printed from among the ID background images stored in the image data storage portion 26 at the time of printing of the receipt 4.

Here, various selection methods are conceivable. Examples of such method include a method, with which the stored multiple ID background images are selected on the average, and a method with which the ID background images are selected in accordance with human-readable information to be printed.

Also, a construction maybe used in which only one ID background image is stored in the image data storage portion 26 and the same ID background image is printed at all times.

The information input portion 31 is constructed using a numeric keypad, a function key, a barcode reader, and the like, and accepts input of commodity identification information identifying commodities, quantities of the commodities, and the like.

Each commodity sold at a store is given a commodity code in the form of a barcode or the like, and the printer 3 stores additional information concerning the commodity, such as a commodity price and a commodity name, in association with the commodity code.

Therefore, it is possible for the printer 3 to perform checkout calculation with reference to each commodity code and its corresponding quantity inputted by a checkout clerk through the information input portion 31.

The print contents generation portion 30 generates items (print contents) to be printed on a receipt based on the commodity code and the quantity inputted through the information input portion 31, the price stored in association with the commodity code, and the like.

The print contents include the name of each commodity purchased, its corresponding quantity, and its corresponding unit price, a total amount of purchase for a checkout, a checkout date and time, a store name and its logo mark, and the like.

It should be noted that among the print contents, items (such as the human-readable information 21 in FIG. 4) printed over the ID background image constitute the human-readable information.

The print information generation portion 28 acquires the ID background image selected by the image data selection portion 27 (ID image acquisition means) and acquires the print contents generated by the print contents generation portion 30 (human-readable information acquisition means: the print contents contain human-readable information to be printed over the ID background image).

Then, the print information generation portion 28 (print information generation means) generates print information by, for instance, arranging the human-readable information acquired from the print contents generation portion 30 in a partial region of the ID background image acquired from the image data selection portion 27.

The arrangement of the human-readable information is achieved through writing the human-readable information over the ID background image. That is, information in a portion, on which the human-readable information is printed, of the ID background image is replaced with the human-readable information.

Therefore, the information of the ID background image is lost in the region in which the human-readable information is printed. However, it is possible to restore the ID pattern from a portion remaining as the background to the extent that the restored ID pattern can be compared with the original image of the ID pattern.

It has been confirmed as a result of experiments that the restoration of the ID pattern is possible even when around 50% of the ID background image is lost on an area basis.

Therefore, the print information generation portion 28 performs its operation so that the area of the region, in which the human-readable information is printed, accounts for 50% or less of the area of the ID background image.

Also, the print information generation portion 28 includes a function of adjusting the density of the ID background image and the density of the human-readable information independently of each other.

This is because the ID background image printed at a high density makes it difficult to visually identify the human-readable information, so the density of the ID background image should be reduced to a minimum for being required to reproduce the ID pattern.

In addition, it is also possible to adjust the density of the human-readable information and of the other print contents to a degree suited for visual observation.

A user (checkout clerk) of the printer 3 is capable of fine-adjusting the densities of the ID background image and the print contents by manipulating the printer 3 referring to a density adjustment screen displayed on a display device of the printer 3 and the like.

Then, information on the densities set by the user is recorded in the print information by the print information generation portion 28, and the printing portion 29 prints a receipt at the set densities.

The printing portion 29 (print means) performs printing onto the print medium in accordance with the print information generated by the print information generation portion 28.

The print medium is constructed of, for instance, a roll of paper wound into a roll to be accommodated, and the printing portion 29 performs printing by forming monochrome dots on the print medium through color development. Note that the printing portion 29 includes a cutter for cutting the print medium at an appropriate position when the printing is ended.

As a print system, it is possible to use various systems of impact systems and of non-impact systems.

One of the examples for the impact system is a system in which a pin of a print head strikes the print medium to transfer ink of an ink ribbon to the print medium.

In the impact system, the ID background image and the print contents are printed by distributing dots of the ink over the print medium in accordance with the print information.

On the other hand, one of the examples for the non-impact system is a thermal transfer system. In the thermal transfer system, thermal ink contained in the print medium develops color by means of Joule heat generated through energization of a thermal head. Printing apparatuses adopting the thermal transfer system are reduced in size and weight, and is maintenance-free, so the thermal transfer system is used in many apparatuses provided with simple printing functions, such as a cash register.

Aside from the thermal transfer system, there are various non-impact systems such as a system based on ink jet technology and a system using a laser.

Also, as a system for adjusting the density of an image, there are a density gradation system and an area gradation system. In the density gradation system, densities in surface elements (cells), which are print units, are changed. In the area gradation system, dot area ratios in the surface elements are changed.

Both of the systems are usable, and the printing portion 29 adopts the area gradation system.

The ID background image is composed of digital data. When area gradations are expressed in a digital system, pixels are generally formed with binary dots.

Therefore, the printing portion 29 has a function of associating the area gradations with binary dots having the same rectangular shape (another shape may be used instead), as shown in a schematic diagram in FIG. 6, and expressing the area gradations through arrangements of the binary dots.

In FIG. 6, a dot having a small area in a surface element 63 is associated with one binary dot in a surface element 64, a dot having a middle area in a surface element 65. is associated with three binary dots in a surface element 66, and a dot having a large area in a surface element 67 is associated with nine binary dots in a surface element 68.

Therefore, the printing portion 29 stores the correspondences between the area gradations and the binary dots, and acquires arrangements of the binary dots corresponding to the densities set by the print information generation portion 28 (binary dot acquisition means).

It should be noted that the correspondences between the area gradations and the binary dot arrangements shown in the schematic diagram in FIG. 6 are merely an example, and various other correspondences are conceivable.

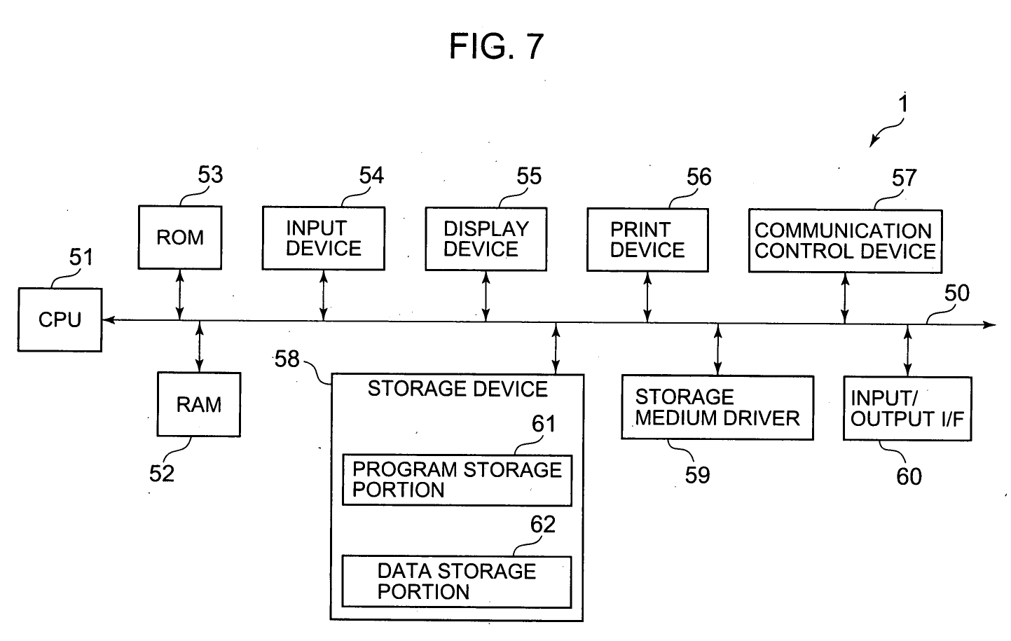

FIG. 7 is a block diagram showing an example of a hardware construction of the printer 3.

As shown in the drawing, the printer 3 is constructed by connecting function portions, such as a central processing unit (CPU) 51, a random access memory (RAM) 52, a read only memory (ROM) 53, an input device 54, a display device 55, a print device 56, a communication control device 57, a storage device 58, a storage medium driver 59, and an input/output interface (I/F) 60, to each other, through a bus line 50.

The CPU 51 is a central processing unit for performing various kinds of operation processing, information processing, control of each construction element of the printer 3, and the like, in accordance with predetermined programs.

In addition to checkout calculation processing, the CPU 51 performs, for instance, processing for receiving ID background images from the URL server 2 and accumulating the received images, processing for synthesizing the ID background images and print contents with each other and printing the synthesized images and print contents on receipts, and the like.

The ROM 53 is a read only memory that has basic programs and data for operating the printer 3 and the like stored therein.

The RAM 52 is a readable/writable memory that provides a working area for the CPU 51 to operate.

The input device 54 is hardware constituting the information input portion 31 (FIG. 5), and includes a numeric keypad, a function key, a barcode reader, and other input devices.

The display device 55 includes a display device for displaying character information and image information, and for displaying, for instance, a total amount of purchase obtained as a result of checkout processing for a customer.

The display device 55 is constructed of for instance, a liquid crystal display, a plasma display, or another display device.

The communication control device 57 is a function portion for connecting the printer 3 to the Internet. The printer 3 is capable of performing communication with the URL server 2 and other server devices through the communication control device 57.

Also, when a sales management server installed in a head office performs sales management, the printer 3 is capable of connecting to the sales management server through the communication control device 57 and transmitting sales data and the like to the server.

The print device 56 is hardware constituting the printing portion 29 (FIG. 5).

The storage medium driver 59 is a function portion for driving a detachably mounted storage medium, and for performing data reading/writing with respect to the medium.

Examples of a readable/writable storage medium include a flexible disk, a magneto-optical disk, a semiconductor memory device, a magnetic tape, and a paper tape.

Also, examples of a read only storage medium include optical disks such as CD-ROMs.

The printer 3 is capable of performing program installation or the like from a storage medium mounted to the storage medium driver 59. In addition, the printer 3 is capable of reading an ID background image stored in a storage medium and accumulating the read image in the image data storage portion 26, and is capable of writing accumulated checkout processing data on the storage medium.

The storage device 58 is a mass readable/writable storage device constructed of a hard disk or the like.

Formed in the storage device 58 are a program storage portion 61 having programs stored therein, and a data storage portion 62 having data stored therein.

In the program storage portion 61, various programs, such as an operating system (OS), a communication program, and a checkout processing program, are stored, and they are executable by the CPU 51.

The OS is a program for causing the CPU 51 to achieve fundamental functions as to running of the printer 3, such as management of file input/output and control of each function portion.

The communication program is a program for causing the CPU 51 to achieve a function of controlling the communication control device 57 and of performing communication through the Internet.

The checkout processing program is a program for having the printer 3 perform checkout processing including the issuance of receipts, and causes the CPU 51 to achieve respective functions such as ID background image selection processing, checkout processing, print contents generation, print information generation, and print processing.

Stored in the data storage portion 62 are ID background images downloaded from the URL server 2, checkout processing data, and the like.

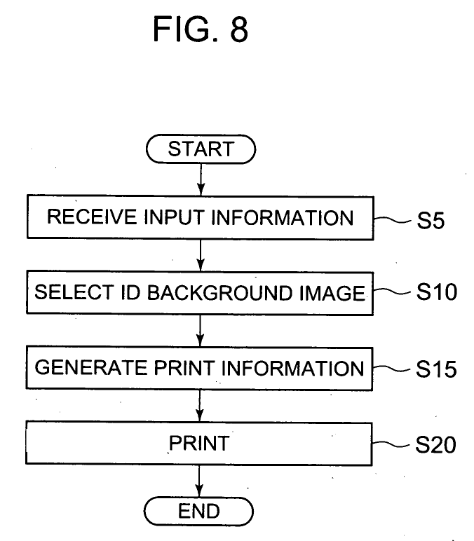

FIG. 8 is a flowchart for explaining a procedure by which the printer 3 prints a receipt.

First, the information input portion 31 accepts input of input information (step 5). The input information includes the code of each commodity purchased, its corresponding quantity, and the like.

Next, the image data selection portion 27 selects an ID background image to be printed from among the ID background images stored in the image data storage portion 26 (step 10).

Then, based on the input information accepted by the information input portion 31, the printer 3 performs checkout calculation, and the print contents generation portion 30 generates print contents that define contents to be printed on a receipt such as the name of each commodity purchased, its corresponding quantity, its corresponding unit price, a total amount of purchase, a purchase date and time, and a store name.

Next, the print information generation portion 28 receives the selected ID background image from the image data selection portion 27, receives the print contents from the print contents generation portion 30, and generates print information using the received ID background image and the received print contents (step 15). Here, human-readable information among the print contents is written over the ID background information.

Next, the printing portion 29 prints a receipt using the print; information generated by the print information generation portion 28 (step 20).

As described above, the printer 3 is capable of printing human-readable information on a receipt with an ID background image as a background at the time of checkout processing.

As a result, the receipt 4 shown in FIG. 4 containing an ID pattern is generated.

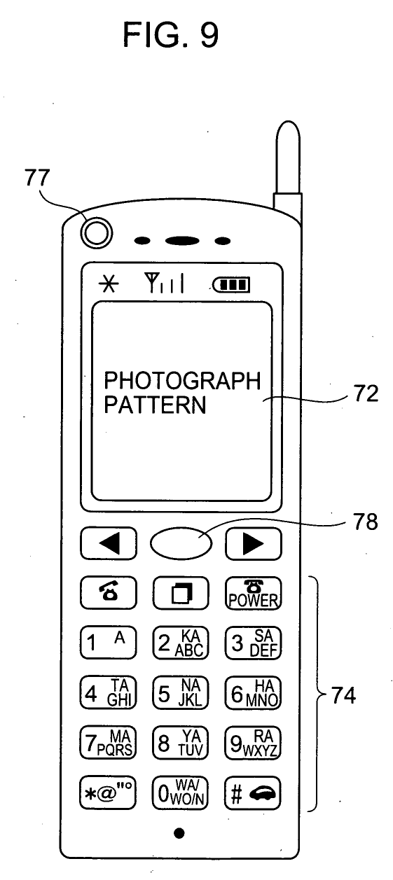

Next, the mobile telephone 5 (FIG. 2) will be described. The mobile telephone 5 is a mobile telephone having a camera function and an Internet connection function. FIG. 9 shows an example of an external appearance of the mobile telephone 5.

As shown in FIG. 9, the mobile telephone 5 includes a camera 77, a display portion 72, a manipulation key 78, and input keys 74.

Also, although not illustrated, the mobile telephone 5 incorporates an information processing portion including a CPU, a ROM, and a RAM, and a readable/writable storage medium including an electrically erasable and programmable ROM (EEPROM) for storing various programs and data.

The CPU of the mobile telephone 5 performs various kinds of information processing in accordance with programs stored in the ROM and other storage media.

The RAM provides a working memory that is used, for instance, when the CPU acquires photographed image data of a receipt, the acquired photographed image data is transmitted to the URL server 2, and a URL is received from the URL server 2 to establish connection to the service server 6.

An application program for photographing of a receipt to establish connection to the service server 6 is stored in a storage medium.

By executing the application program, the CPU is capable of realizing a function of establishing connection to the URL server 2 and transmitting photographed image data of a receipt, a function of receiving a URL transmitted from the URL server 2 in response to the transmitted photographed image data, and a function of establishing connection to a website designated by the received URL based on the URL.

In addition, a browser program is also stored in the storage medium, and the CPU is also capable of achieving a browser function using the browser program.

The camera 77 includes an optical system composed of a lens and the like, and a charge coupled device (CCD) that converts an image of a subject projected by the optical system into digital data. When a customer photographs a receipt with the camera 77, photographed image data of the receipt is generated by the CPU.

The display portion 72 is constructed of, for instance, a liquid crystal display, and displays information related to a telephone call, such as a telephone number. In addition, the display portion 72 is capable of displaying, via the browser, various screens transmitted from websites through the Internet.

The manipulation key 78 is used by the customer to perform various screen manipulations with respect to the screens displayed on the display portion 72, such as to select any of the icons displayed on the display portion 72 and to select any of the links.

The input keys 74 are used by the customer to input numerals, characters, symbols, and the like into the mobile telephone 5.

With the mobile telephone 5 constructed in the manner described above, it becomes possible for the customer to photograph a receipt and automatically establish connection to a website designated by an ID background image of the receipt.

It should be noted that in this embodiment, Fourier transform of photographed image data and extraction of an ID pattern are performed by the URL server 2. However, a construction, in which the processing is performed by the mobile telephone 5 and an extracted ID pattern is transmitted from the mobile telephone 5 to the URL server 2, may be used instead.

In this case, the storage medium has the application program stored therein, in which information for causing the CPU to perform processing for Fourier-transforming photographed image data and processing for extracting an ID pattern from data after the Fourier transform is described.

Also, in this embodiment, a construction is used in which processing, such as photographing of a receipt, is performed by the mobile telephone 5, although the same function may be realized by another kind of terminal.

For instance, it is possible to realize the function by a personal digital assistant (PDA), a game machine, a personal computer, or the like equipped with a camera and the application.

Next, the service server 6 (FIG. 2) will be described. The service server 6 is a web server and operates a website designated by a URL.

An operator of the website is capable of providing terminal devices with characters, still images, moving images, audio, link information, and the like on the website.

A hardware construction of the service server 6 is fundamentally the same as that of the URL server 2.

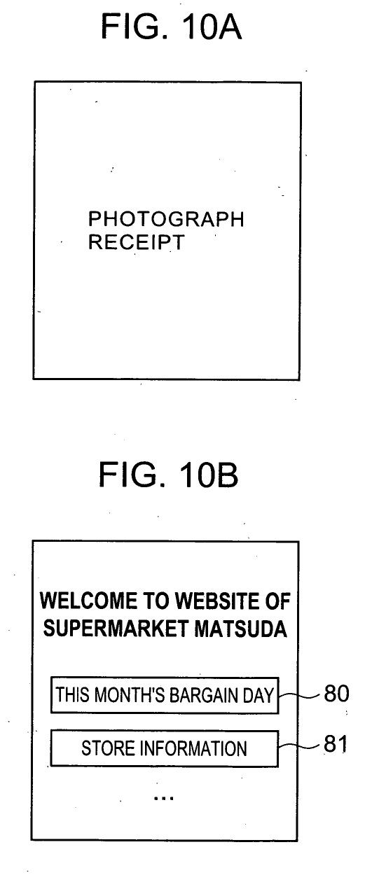

Next, screens displayed on the display portion 72 of the mobile telephone 5 will be described with reference to FIGS. 10A and 10B.

FIG. 10A shows an example of a screen that is displayed on the display portion 72 when the application program is started at the mobile telephone 5.

In the example shown in FIG. 10A, a message for prompting the customer to photograph a receipt, such as “Photograph receipt”, is displayed on the display portion 72.

In accordance with the instruction, the customer photographs with the camera 77 a receipt that has been received at the time of checkout.

FIG. 10B shows an example of a screen that is displayed on the display portion 72 when the mobile telephone 5 is connected to the website operated-by the service server 6.

When the customer photographs the receipt, the mobile telephone 5 performs a series of processing so that the screen shown in FIG. 10B is automatically displayed on the display portion 72. The series of processing performed by the mobile telephone 5 includes transmitting photographed image data to the URL server 2, connecting to the service server 6 based on a URL sent from the URL server 2 in response to the transmitted photographed image data, and interpreting and displaying a top screen transmitted from the service server 6 through the mediation of the browser.

The displayed top screen contains a button 80 which reads “This month's bargain day”, a button 81 which reads “Store information”, and the like.

The customer can select a desired button from among the buttons using the manipulation key 78 and the input keys 74 (FIG. 9).

For instance, when the button 80 is selected, screen data concerning this month's bargain days is transmitted from the service server 6 and is displayed on the display portion 72.

Also, when the button 81 is selected, screen data concerning store information is transmitted from the service server 6 and is displayed on the display portion 72.

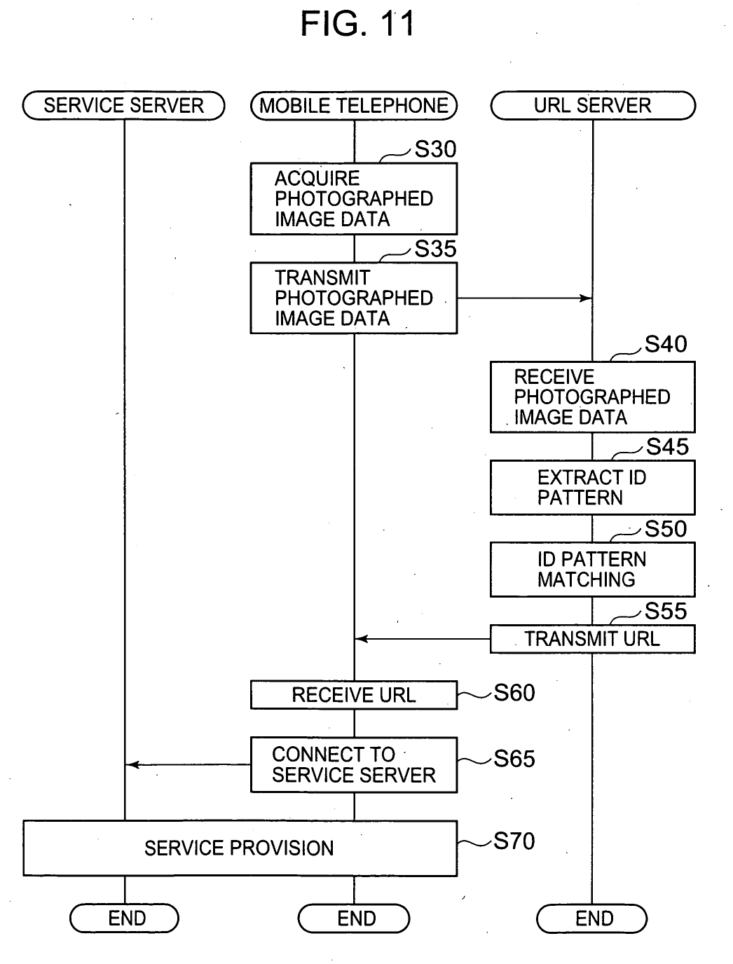

FIG. 11 is a flowchart for explaining a procedure by which the mobile telephone 5 connects to the service server 6.

First, the customer receives a receipt issued at the time of checkout at a store. Then, the customer starts the application of the mobile telephone 5 and photographs the receipt with the mobile telephone 5.

As a result, the mobile telephone 5 acquires photographed image data of the receipt (step 30).

Then, the mobile telephone 5 connects to the URL server 2 and transmits the acquired photographed image data to the URL server 2 (step 35).

The URL server 2 receives the photographed image data from the mobile telephone 5 (step 40).

Next, the URL server 2 Fourier-transforms the photographed image data and extracts an ID pattern from data after the Fourier transform (step 45).

Then, the URL server 2 conducts a search by comparing the extracted ID pattern with the ID patterns registered in advance in the ID database, and identifies the ID pattern contained in the photographed image data (step 50).

After the ID pattern is identified, the URL server 2 acquires a URL associated with the ID pattern in the ID database and transmits the URL to the mobile telephone 5 (step 55).

The mobile telephone 5 receives the URL from the URL server 2 (step 60), and connects to the service server 6 based on the URL (step 65).

When the connection from the mobile telephone 5 has been established, the service server 6 transmits top page screen data to the mobile telephone 5 and remains ready to provide the mobile telephone 5 with service (step 70).

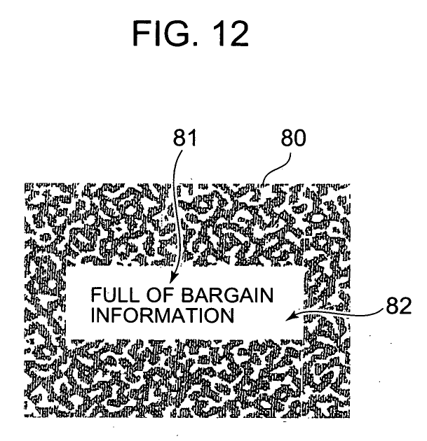

FIG. 12 shows a modification of the ID background image printing method.

In this example, an ID background image 80 is provided with a hollow region 82, in which print contents 81 are printed.

As in the manner described above, by providing a blank region to be filled with the print contents to be printed, the print contents can be printed to be visually recognized with more ease.

It is possible to restore an ID pattern to an identifiable level even when around 50% of the ID background image is lost, so it is possible to erase a part of the ID background screen in the manner described above.

In the embodiment described above, the Fourier transform is adopted for embedding the ID pattern using the frequency domain technique, although this is merely an example and it is possible to adopt another transform such as a discrete cosine transform (DCT) or a wavelet transform.

Also, in the embodiment, an example has been described in which an ID background image is printed on a receipt issued at the time of checkout at a store or the like, although the application of the ID background image is not limited to this, and it is possible to apply the ID background image to various other kinds of printed matter, such as magazines, newspapers, and posters. Further, the ID background image is not limited to printing on print media and may be displayed on display devices such as a display.

Still further, in the embodiment, ID patterns and URLs are associated with each other, although this is merely an example, and another information, such as images, audio or characters, may be associated with the ID patterns.

For instance, a quiz may be printed as human-readable information over an ID background pattern and an answer of the quiz may be associated with an ID pattern, so that the answer of the quiz may be presented through photographing of the ID background pattern.

According to the embodiment described above, the following effects are provided.
(1) It becomes possible to define an ID pattern in a frequency domain and print the print contents with the ID pattern as a background.
(2) It becomes possible to adjust the density of the ID background image and the density of the print contents independently of each other.
(3) The print contents are written over the ID background image, so it becomes possible to implement the present invention even in a printing apparatus not having a sophisticated image-processing function.
(4) The ID pattern is defined in the frequency domain, so even when the ID background image is deteriorated due to print accuracy or the like, it becomes possible to restore the ID pattern to a degree that the restored ID pattern can serve for matching. Therefore, it becomes possible to perform printing with a compact, lightweight, and simple printing apparatus whose print accuracy is low.
(5) The print contents are written over the ID background image, so it becomes possible to save a print surface of a print medium. As a result, even when a small piece of paper is used as a print medium, it becomes possible to appropriately give the ID pattern to the print medium.
(6) It becomes possible to automatically connect a mobile telephone to a website associated with the ID pattern through photographing of the medium, on which the ID background image has been printed, with the mobile telephone.
(7) It becomes possible to provide a customer with various kinds of information, such as characters, still images, moving images, audio, and link information, on the website to which the mobile telephone has been automatically connected.

What is claimed is:

1. A printing apparatus comprising:
ID image acquisition means for acquiring an ID image in which ID information has been defined in a frequency domain;
human-readable information acquisition means for acquiring human-readable information including at least one of a character and an image;
print information generation means for generating print information by arranging the acquired human-readable information in a partial region of the acquired ID image; and
print means for printing the ID image and the human-readable information on a print medium using the generated print information.

2. A printing apparatus according to claim 1, wherein an area of the partial region is 50% or less of an area of the ID image.

3. A printing apparatus according to claim 1, further comprising binary dot acquisition means for acquiring a predetermined arrangement of binary dots in accordance with a gradation of a surface element that is a print unit,
wherein the binary dot acquisition means acquires an arrangement of binary dots for each surface element of the generated print information, and the print means prints the acquired arrangement of binary dots in monochrome.

4. A printing apparatus according to claim 3, where in the binary dot acquisition means adjusts density of the ID image using a gradation system based on the arrangement of binary dots.

5. A printing method used for a computer, which includes ID image acquisition means, human-readable information acquisition means, print information generation means, and print means, the printing method comprising:
acquiring an ID image having ID information defined in a frequency domain, through the ID image acquisition means;
acquiring human-readable information including at least one of characters and images, through the human-readable information acquisition means;
generating print information through the print information generation means, by arranging the acquired human-readable information in a partial region of the acquired ID image; and
printing the ID image and the human-readable information on a print medium using the generated print information, through the print means.

6. A printing program for causing a computer to implement:
an ID image acquisition function for acquiring an ID image having ID information defined in a frequency domain;
a human-readable information acquisition function for acquiring human-readable information including at least one of a character and an image;
a print information generation function for generating print information by arranging the acquired human-readable information in a partial region of the acquired ID image; and
a printing function for printing the ID image and the human-readable information on a print medium using the generated print information.
